(19) United States
(12) Patent Application Publication
(10) Pub. No.: US 2014/0022761 A1
(43) Pub. Date: Jan. 23, 2014

(54) Luminescent Converter and LED Light Source Containing Same

(71) Applicant: Peipei H. Wei, (US)

(72) Inventors: George C. Wei, Weston, MA (US); Madis Raukas, Lexington, MA (US); Adam M. Scotch, Amesbury, MA (US); Darshan Kundaliya, Beverly, MA (US)

(73) Assignee: OSRAM SYLVANIA INC., Danvers, MA (US)

(21) Appl. No.: 13/980,387

(22) PCT Filed: Jan. 20, 2012
(86) PCT No.: PCT/US2012/021982

§ 371 Date: Oct. 7, 2013

Related U.S. Application Data
(60) Provisional application No. 61/434,848, filed on Jan. 21, 2011.

(51) Int. Cl. F21K 99/00

(52) U.S. Cl. CPC F21K 9/56
USPC 362/84

(57) ABSTRACT

A luminescent converter for a light emitting diode is herein described. The converter comprises a translucent substrate and a thin-film layer deposited on the substrate wherein the thin-film layer is comprised of a phosphor. The translucent substrate may further comprise a solid, ceramic phosphor such as YAG:Ce.

### CROSS REFERENCE TO RELATED APPLICATIONS

This application claims the benefit of U.S. Provisional Application No. 61/434,848, filed Jan. 21, 2011.

### TECHNICAL FIELD

This invention relates to light emitting diodes (LEDs) and in particular to phosphor-converted LEDs (pc-LEDs) wherein the light emitted by the LED is at least partially converted into light having a different peak wavelength.

### BACKGROUND OF THE INVENTION

In a typical conversion-based white-light LED, the UV or blue light emitted by the LED semiconductor die strikes the phosphor conversion layer to produce light of other wavelengths. In one of the common configurations, white pc-LEDs are based on mixing the blue emission from the InGaN LED die with the light emitted by the phosphor upon excitation by the same blue light. The phosphor layer changes one or more parameters of the light (directionality, polarization, frequency) emitted from the die. Typically, the phosphor is in contact with the die (phosphor-on-chip) or lies in a larger volume above it, mixed into the resin. Alternatively, the phosphor can be positioned a defined distance away from the emitting die. In the cases mentioned, the phosphor has been typically applied in its powder form.

It may be advantageous from the efficiency or ease of manufacturing point of view to utilize solid, ceramic phosphor layers rather than powders, See e.g., International Patent Publication No. WO 2008/056300. However, independent of the exact placement and shape of the phosphor layer it is important to strike the right balance between the absorption and transmission of the exciting blue or UV radiation so that the cumulative spectrum exhibits the necessary properties, for example a desired color rendering index (CRI) or correlated color temperature (CCT). Apart from the emission characteristics of the LED die, this balance depends on several inherent parameters of the conversion layer such as scattering, absorption coefficient, thickness, distance between the conversion layer and the die, and path length through the converter for all angles. Incident blue light scatters inside the conversion layer so that a fraction of it is reflected back, another fraction transmitted and yet another fraction absorbed by the material. Radiation absorbed in the conversion layer is converted to a different color, emitting its different color photons isotropically. This converted light is further scattered in all directions by scattering centers or interfaces inside the material. In order to create an efficient LED light source, the amount of light directed back toward the die after being scattered and/or reflected by the converter together with any re-absorption of converted light within the converter itself needs to be minimized. The fraction of blue and other wavelengths in the forward direction has to be maximized. The latter, “useful” output of the light source will have to exhibit the carefully balanced spectral power distribution mentioned above. This must be accomplished by carefully controlling the number of scattering centers or interfaces in the light path and typically calls for lowest possible amount from the point of view of mixing photons of different color. Highly dense, low-porosity homogeneous materials have been shown to significantly improve the light output from blue-pumped, phosphor conversion LEDs. In the other, UV-conversion scheme, the exciting UV photons will have to be absorbed completely in the conversion layer and the converted visible light extracted from the source as efficiently as possible in accordance with the above described principles apply.

### SUMMARY OF THE INVENTION

The present invention utilizes luminescent converters that have one or more thin-film conversion layers that have been deposited on a translucent substrate. The thin films may be applied by a number of thin-film deposition techniques including pulsed laser deposition (PLD), pulsed e-beam deposition (PED), molecular beam epitaxy, and ion beam, DC, RF, or arc-plasma sputtering.

The luminescent converter is used in conjunction with blue- and/or UV-emitting LEDs. The thin-film deposition method of choice is used to produce red-, amber-, yellow-, green-, blue-green- or blue-emitting inorganic converter thin-film layers on translucent substrates that may also comprise a luminescent converter such as a monolithic ceramic or single-crystal converter. Preferably, the thin-film layer(s) produce complementary color(s) in a manner that the cumulative emission from the LED is perceived by the viewer as white light. The substrate structure includes configurations of platelets, cups, or domes. Preferably, the substrates are thin, flat rectangular plates that are suitable for being affixed to the surface of the LED die.

### BRIEF DESCRIPTION OF THE DRAWINGS

FIG. 1 is a cross-sectional illustration of an LED having a luminescent converter with two thin-film conversion layers.

FIG. 2 is a cross-sectional illustration of an LED having a dome-shaped luminescent converter with a single thin-film conversion layer.

FIG. 3 is a photoluminescence (PL) spectrum of an annealed, as-grown thin film of a red-emitting nitride phosphor.

### DETAILED DESCRIPTION OF THE INVENTION

As used herein, the following terms have the following meanings:

“Thin-film layer” means a layer of a film that is continuous within its boundaries and that has a substantially homogenous composition and a thickness of less than twenty micrometers. It does not comprise films or layers comprised of particulate materials that may or may not be bound together by an organic material such as a resin or polymer or sintered together to form a solid monolithic piece.

“Translucent substrate” means that the substrate will allow at least a portion of the light emitted by a light source to pass through it without being absorbed. The term “translucent substrate” also includes substrates that are transparent whereby the light passes through the substrate without significant scattering.

“White light” means light that the ordinary human observer would consider “white” and includes, but is not limited to, light that may be more biased to the red (warm white light) and light that may be more biased to the blue (cool white light).

References to the color of a phosphor, LED or substrate refer generally to its emission color unless otherwise specified. Thus, a blue LED emits a blue light, a yellow phosphor emits a yellow light and so on.

In one embodiment, the luminescent converter of this invention may comprise a thin-film layer of YAG:Ce (Y₃Al₅O₁₂:Ce³⁺) that emits a shorter-wavelength (yellow) light and a thin-film layer of nitride phosphor such as (Ba,Sr,Ca)₂Si₅N₈:Eu or (Ba,Sr,Ca)AlSiN₃:Eu that emits a longer-wavelength (red) light, wherein the combined emission from the LED is a warm white light.

In a second embodiment, the luminescent converter of this invention may comprise a longer-wavelength (red) thin-film layer of a nitride phosphor deposited on a translucent substrate comprised of the shorter-wavelength YAG:Ce phosphor as a solid, sintered polycrystalline body, or a sintered-converted-to-single-crystal body, or melt-grown single-crystal of YAG:Ce. Conversion of the blue excitation radiation by the two conversion elements (thin film and substrate) produces once again a warm white light.

In a third embodiment, the luminescent converter of this invention may comprise a shorter-wavelength (yellow) thin-film layer of a garnet or orthosilicate phosphor deposited on a nitride phosphor ceramic substrate comprised of the longer-wavelength (for example (Ba,Sr,Ca)₂Si₅N₈:Eu or (Ba,Sr,Ca)AlSiN₃:Eu) phosphor as a solid, sintered polycrystalline body, or a sintered-converted-to-single-crystal body, or melt-grown single-crystal of these or other red phosphors. Conversion of the blue excitation radiation by the two conversion elements (thin film and substrate) produces once again warm white light.

Preparation of fully dense, low-porosity phosphors of any emission color is typically not straightforward. Traditionally, metal oxide materials of various structure have been shown to produce ceramics far more easily than others. Many phosphors such as the red-emitting nitride phosphor (Sr,Ca)₂Si₅N₈:Eu have low sinterability due to decomposition before onset of densification at high temperatures. Hot pressing or sinter-HIPing is believed to be required to form a translucent (Sr,Ca)₂Si₅N₈:Eu ceramic.

Thin films of the red-emitting phosphor may be produced by PLD, for example, using sintered (Ba,Sr,Ca)₂Si₅N₈:Eu or (Ba,Sr,Ca)AlSiN₃:Eu as a target. As such a thin-film layer of the red-emitting nitride phosphor may be directly deposited on a preformed and sintered YAG:Ce ceramic substrate (platelets, cups, or domes). One should not, however, limit the choice of phosphor materials for deposition to nitrides or oxynitrides only. There is a growing number of LED phosphor converters that cover the entire spectrum from blue to red. It is likely that in addition to YAG:Ce several other phosphors lend themselves to the formation of solid ceramic substrates while there exist also phosphors suitable for relatively easy, low-cost thin-film deposition.

The thickness, composition and sequence of the layers determine the color output of the source via their absorption, emission and scattering parameters. Achieving the desired CCT, CRI and luminance of the source may require some layers to be thick and strongly scattering but of low absorption while the others need to be thin, strongly absorbing and with little or no scattering. As a step beyond conventional yellow-emitting YAG:Ce converters that enable cool-white LEDs, an LED device that produces better quality warm-white light requires the addition of a strong red component to its output. This may be done by adding the thin films of red phosphors to the ceramic polycrystalline or single-crystal, cool-white converter (typically YAG:Ce). It may be necessary for the red-emitting layer to be the first one on the path of the blue LED emission in order to avoid re-absorption of shorter wavelengths emitted by other layers. The red-emitting phosphors typically have absorption bands that extend farther into the visible spectral range. Orange or red phosphors known and useable with blue-light-emitting LEDs include: Ca₂Si₅N₈:Eu²⁺, (Sr,Ca)₂Si₅N₈:Eu²⁺, M₂Si₅N₈:Eu, (Sr,Ca)AlSiN₃:Eu, Ca-α-SiAlON:Eu²⁺ (Ca_{m/2}Si₁₂₋ₘ₋ₙAlₘ₊ₙOₙ, N₁₆₋ₙ :Eu²⁺), SrBaCaSiAlNO:Eu, LuYAlSiON:Ce, Pr, CaSiN₂:Ce³⁺, (Sr,Ba)₃SiO₅:Eu²⁺, Y₂O₃:Eu,Bi, Ca₂NaMg₂V₃O₁₂:Eu³⁺, and MGa₂S₄:Eu²⁺ wherein M is an alkaline earth.

PLD is one of the preferred methods for the preparation of thin luminescent films. Controlling film morphology allows for the optimization of scattering and absorption parameters of the films, thus improving conversion-extraction efficiency. For example, in the deposition of (Sr,Ca)₂Si₅N₈:Eu, the chamber of PLD should have a partial pressure of both N₂ and H₂ in order to avoid lattice vacancies and keep the Eu species at the desired 2+ oxidation state required for broadband red emission. Single-crystal YAG:Ce may be better than a sintered polycrystalline substrate for PLD in terms of bonding and texture formation. The technique of converting polycrystalline YAG:Nd rods into single-crystal YAG:Nd rods can be applied to sintered YAG:Ce. Single-crystal YAG:Ce platelets, cups or domes can then be applied as substrates for PLD of red phosphors such as (Sr,Ca)₂Si₅N₈:Eu. Additionally, other physical parameters like lattice structure and thermal expansion coefficient must be considered in forming the converter of multiple layers. The thermal expansion of red nitride phosphors are lower than that of YAG:Ce. Therefore the thickness of the PLD nitride layer may have to be limited to avoid cracking. Other red phosphors such as Y₂O₃:Eu, vanadate garnet, SrBaCaSiAlNO:Eu, and LuYAlSiON:Ce,Pr, may have thermal expansions and lattice constants closer to YAG:Ce, but their conversion efficiencies are currently lower than (Sr,Ca)₂Si₅N₈:Eu. Alternatively, thin buffer layers on the order of several hundred angstroms can be applied between the YAG:Ce substrate and the nitride films. This technique has been shown to be effective in reducing film stress in other material systems.

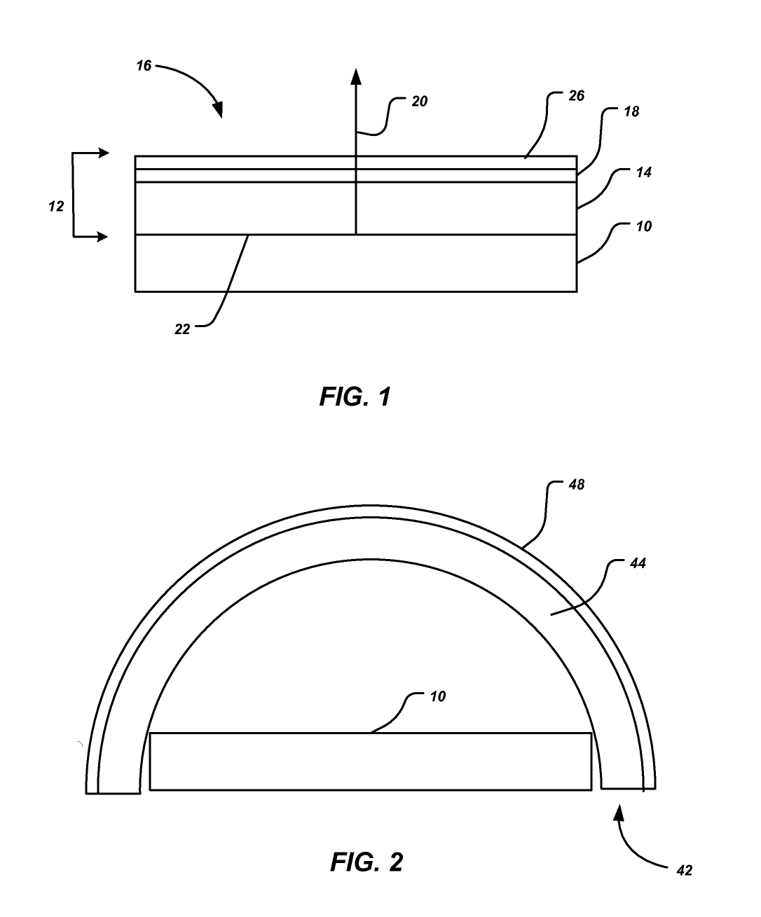

In one preferred embodiment of an LED light source 16 according to this invention, a light emitting diode (LED) semiconductor die 10 emits light from its light emitting surface 22 in the direction indicated by arrow 20. The light emitted by the LED has a peak wavelength in the UV or blue region of the electromagnetic spectrum. The light emitted by the LED die 10 strikes a luminescent converter 12. The luminescent converter 12 absorbs at least a portion of the light emitted by the LED die 10 and converts it into light having a different peak wavelength than the light emitted by the LED die. In this embodiment, the converter 12 comprises a translucent substrate 14 and at least two thin-film layers 18, 26 of phosphor materials that are capable of being excited by the light emitted by the LED die 10 in the manner described above. Preferably, thin-film layer 18 is comprised of a red-emitting nitride phosphor and thin-film layer 26 is comprised of a yellow-emitting YAG:Ce phosphor. In this embodiment, the converter 12 entirely covers the light emitting surface 22 of the LED die 10 and preferably may have a shape of a rectangular platelet (as in FIG. 1) or dome (as in FIG. 2).

In another embodiment shown in FIG. 2, the luminescent converter 42 is comprised of a translucent substrate 44 and thin-film layer 48. The translucent substrate 44 is a monolithic ceramic converter comprised of a YAG:Ce phosphor formed into a dome shape. The LED die 10 emits a blue light having a peak wavelength from about 420 nm to about 490 nm and a portion of the blue light emitted by the LED die is converted into a yellow emission by the translucent substrate 44. The unconverted blue light then passes into the thin-film layer 48 which is preferably comprised of a red-emitting phosphor that has been deposited on the exterior surface of the domed substrate 44. The red-emitting phosphor in the thin-film layer 48 further absorbs some of the blue light to generate a red emission. The remaining blue light that exits the luminescent converter together with the yellow and red emissions from the luminescent converter combine to generate an overall warm white light. The thin-film layer of the red-emitting phosphor may also be deposited on the interior surface of the domed substrate instead of its exterior surface as illustrated in FIG. 2.

### EXAMPLE 1

### Thin Films of Red-Emitting Phosphors

Thin films of (Sr,Ca)₂Si₅N₈:Eu²⁺ and Ca₂Si₅N₈:Eu²⁺ were grown using PLD in ammonia and nitrogen atmospheres. The PLD is an ideal technique for reproducing bulk phosphor properties for such a complex stoichiometric material. The substrates used were c-Al₂O₃, r-Al₂O₃, SiNₓ/c-Al₂O₃, and quartz. In the case of SiNₓ/Al₂O₃ as substrate, the silicon nitride buffer layer helps incorporation of nitrogen into the as-grown thin film during post annealing steps to obtain a highly efficient phosphor. Another benefit of the buffer layer is to keep oxygen from diffusing in from the oxide substrates. Substrate temperature during deposition was varied from 700° C.-875° C.

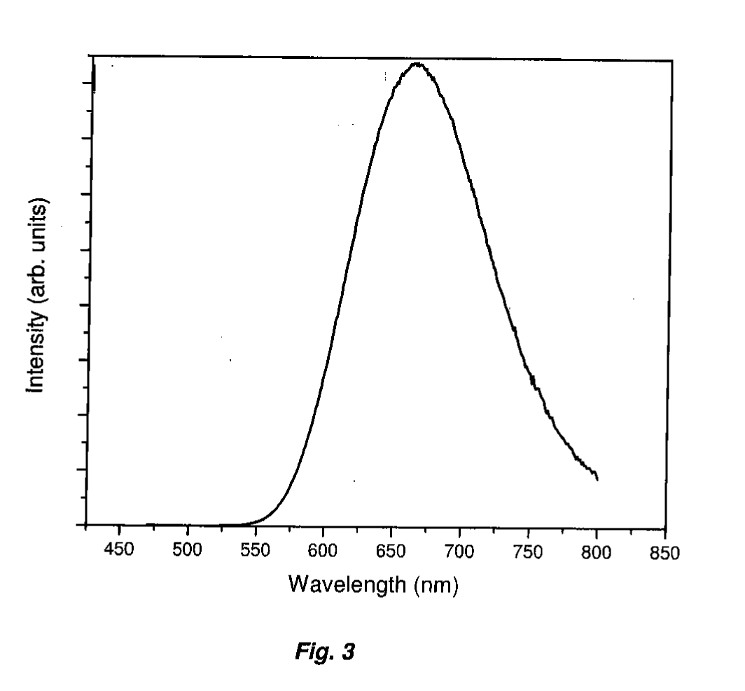

As-grown films did not show significant photoluminescence. Photoluminescence from the deposited structures is observed only after annealing the samples which can be performed in a conventional furnace with a controlled atmosphere. The temperature used for annealing was 1400° C. FIG. 3 shows the photoluminescence spectrum for a post-annealed film.

Nitride phosphors such as (Sr,Ca)₂Si₅N₈:Eu are highly expensive due to difficulties in obtaining stoichiometric powders with a desired particle size. In a pulsed-laser, thin-film deposition technique, instead of using targets made of a fully reacted nitride phosphor material that may have a high cost associated with it, one can grow nitrogen deficient films from the metal composite (alloy) target (or by using individual metal element targets) in an ammonia atmosphere. These nitrogen deficient films can be further processed into stoichiometric nitride films yielding a highly cost effective method for manufacturing layered phosphor systems.

### EXAMPLE 2

### YAG:Ce Thin Films on Nitride Phosphor Ceramics

Thin films YAG:Ce were grown on nitride phosphor ceramics using pulsed laser deposition. Amber- and red-emitting nitride phosphor ceramic chips (1 mm²) were used for YAG:Ce thin film growth. The deposition of YAG:Ce films was at room temperature followed by annealing in a belt furnace at 1500° C., 1400° C. and 1350° C. After annealing these luminescent converters were placed on a blue LED. The CIE color coordinates and correlated color temperatures (CCT) of all the samples with different configurations (“YAG:Ce film facing down” or “YAG:Ce film facing up” on LED) were measured and are shown in Table 1 below. In general, the configuration with the YAG:Ce film facing down (towards the LED chip) enables first the partial conversion of the blue light emitted by the LED to a yellow light which tunes the color point. Most or all of the remaining blue light is then absorbed by the nitride ceramic to generate a red or amber emission. Higher CCT values are observed for the “facing down” configuration. Similarly CRI values were also higher, 63-65, for the “facing down” configuration compared to CRI values below 50 for the “facing up” configuration.

TABLE 1

| | Emission | | | | |
|---|---|---|---|---|---|
| | Color of | YAG:Ce film | x color | y color | |
| Sample | Substrate | orientation | coordinate | coordinate | CCT(K) |
| 1 | Red | Facing Up | 0.502 | 0.292 | 1442 |
| 1 | Red | Facing Down | 0.450 | 0.341 | 1759 |
| 2 | Amber | Facing Up | 0.445 | 0.295 | 1919 |
| 2 | Amber | Facing Down | 0.394 | 0.285 | 2601 |
| 3 | Amber | Facing Up | 0.526 | 0.353 | 1640 |
| 3 | Amber | Facing Down | 0.392 | 0.258 | 2300 |

While there have been shown and described what are at present considered to be preferred embodiments of the invention, it will be apparent to those skilled in the art that various changes and modifications can be made herein without departing from the scope of the invention as defined by the appended claims.

We claim:

1. A luminescent converter for a light emitting diode, the converter comprising a translucent substrate and a thin-film layer deposited on the substrate wherein the thin-film layer is comprised of a phosphor.

2. The luminescent converter of claim 1 wherein the thin-film layer comprises a red-emitting phosphor.

3. The luminescent converter of claim 1 wherein the translucent substrate is comprised of YAG:Ce and the thin-film layer comprises a red-emitting phosphor.

4. The luminescent converter of claim 2 wherein a second thin-film layer of a YAG:Ce phosphor is deposited on the thin-film layer.

5. The luminescent converter of claim 1 wherein the substrate has a dome shape.

6. The luminescent converter of claim 5 wherein the thin-film layer is deposited on an exterior surface of the substrate.

7. The luminescent converter of claim 5 wherein the thin-film layer is deposited on an interior surface of the substrate.

8. The luminescent converter of claim 1 wherein a buffer layer is deposited between the substrate and the thin-film layer.

9. The luminescent converter of claim 1 wherein the translucent substrate is comprised of (Ba,Sr,Ca)₂Si₅N₈:Eu or (Ba,Sr,Ca)AlSiN₃:Eu.

10. The luminescent converter of claim 9 wherein the thin-film layer comprises a YAG:Ce phosphor.
